(19) United States
(12) Patent Application Publication
(10) Pub. No.: US 2026/0054964 A1
(43) Pub. Date: Feb. 26, 2026

(54) POSITIONING AND CLAMPING APPARATUS FOR CELL ELECTRODE PLATE GROUPS, LEAD BRIDGES, AND LEAD HEADS OF LEAD-ACID BATTERY

(71) Applicant: BATTERY TECHNOLOGY SOURCE CO. LTD., TAICHUNG CITY (TW)

(72) Inventor: FU MEI HO, TAICHUNG CITY (TW)

(21) Appl. No.: 18/813,224

(22) Filed: Aug. 23, 2024

(51) Int. Cl. B66C 1/42; H01M 10/04; H01M 10/14

(52) U.S. Cl. CPC B66C 1/42; H01M 10/0404; H01M 10/0481; H01M 10/14

(57) ABSTRACT

A positioning and clamping apparatus includes a hoisting unit including a support plate, two piston members, two first actuators, two hoisting plates, and an interconnection plate; a transporting unit including a second actuator, two movement rods, and a transporting plate; and a micro adjustment positioning unit including a limiting plate, two follower plates, two sliding members, a third actuator, and a positioning plate. The positioning and clamping apparatus is used for cell electrode plate groups, lead bridges, and lead heads of a lead-acid battery.

### FIELD OF THE INVENTION

The invention relates to lead-acid batteries and more particularly to a positioning and clamping apparatus for cell electrode plate groups, lead bridges, and lead heads of a lead-acid battery.

### BACKGROUND OF THE INVENTION

Lead-acid batteries are widely used in motor vehicles or uninterruptible power supplies (UPSs). With the advancement of technology, the size of lead-acid battery becomes smaller, and its density is also increased. The conventional lead-acid battery comprises a plurality of compartments disposed in a housing. Each compartment accommodates a cell electrode plate group. The cell electrode plate group comprises a plurality of electrode plates and a plurality of separation plates alternated and stacked. A tab protrudes from a top of each electrode plate. These tabs are respectively connected to one of a plurality of lead bridges that supply electric current to each electrode plate in series based on anode of the electric current entering it and cathode of the same leaving it. Thus, the electric current flows from the anode to the cathode through the lead bridge. At the same time, a lead head is provided on one of the lead bridges of each cell electrode plate group at either side. The lead heads are electrically connected to external terminals so that the external terminals can supply power.

However, regarding the conventional lead-acid batteries it is required to manually place the cell electrode plate group in the compartment, and an employee must use a tool to press the lead bridges so that the cell electrode plate groups can be correctly positioned and fastened in each compartment. In addition, for joining the lead heads and the lead bridges it is required to place the lead heads on a frame, and then bring the lead bridges close to the frame. Thereafter, the employee may use the tool to join the lead heads and the lead bridges prior to using a soldering gun to fasten them together by molten solder. Unfortunately, the above process of assembling the lead-acid battery is labor-intensive and time-consuming in addition to low efficiency.

Thus, the need for improvement still exists.

### SUMMARY OF THE INVENTION

It is therefore one object of the invention to provide a positioning and clamping apparatus for cell electrode plate groups, lead bridges, and lead heads of a lead-acid battery, comprising a hoisting unit comprising a support plate, two piston members, two first actuators, two hoisting plates, and an interconnection plate wherein the piston members are disposed on two sides of the support plate respectively, the first actuators are disposed on the sides of the support plate respectively, the piston member is adjacent to the first actuator of the same side, the hoisting plate is disposed on tops of both the piston member and the first actuator of the same side, each of the first actuators include a first piston threadedly secured to the hoisting plate, the interconnection plate is disposed across the hoisting plates, and the first pistons are configured to threadedly raise or lower the hoisting plates which in turn raise or lower the interconnection plate; a transporting unit comprising a second actuator, two movement rods, and a transporting plate wherein the second actuator and the movement rods are disposed on the support plate, the second actuator includes two parallel second pistons secured to the transporting plate, the movement rods are disposed at two sides of the second actuator respectively, first ends of the movement rods are secured to the transporting plate, and the transporting plate is disposed at a first end of the support plate so that the second pistons are configured to move the movement rods and the transporting plate forward or rearward; and a micro adjustment positioning unit comprising a limiting plate, two follower plates, two sliding members, a third actuator, and a positioning plate wherein the limiting plate is disposed on a first end of the transporting plate opposing the support plate, the follower plate is disposed under the hoisting plates and secured to the limiting plate, each of the sliding members are disposed between the hoisting plate and the follower plate of the same side, the third actuator is secured to the interconnection plate and includes a third piston passing through the interconnection plate and threadedly secured to the positioning plate, and the positioning plate is secured to the follower plate so that the third piston is configured to move the positioning plate forward or rearward and in turn the positioning plate is configured to move the follower rods and the limiting plate forward or rearward.

The invention has the following advantages and benefits in comparison with the conventional art: the transporting unit and the micro adjustment positioning unit may be activated to cause the limiting plate to contact the transporting plate. Thus, the lead bridge and the lead head at the same side of the lead-acid battery are joined. This finishes the positioning and clamping process of the lead bridge and the lead head. The drawbacks of the conventional assembling process of the lead-acid battery are eliminated. Moreover, both labor and time are saved, and efficiency is increased.

The above and other objects, features and advantages of the invention will become apparent from the following detailed description taken with the accompanying drawings.

### BRIEF DESCRIPTION OF THE DRAWINGS

FIG. 1 is a perspective view of a bed with a positioning and clamping apparatus according to a preferred embodiment of the invention mounted thereon and a controlling unit mounted on the positioning and clamping apparatus;

FIG. 2 is a perspective view of the positioning and clamping apparatus;

FIG. 3 is another perspective view of the positioning and clamping apparatus;

FIG. 4 is a side elevation of the positioning and clamping apparatus;

FIG. 5 is an exploded view of an upper portion of the positioning and clamping apparatus;

FIG. 6 is an exploded view of a lower portion of the positioning and clamping apparatus;

FIG. 7 is a perspective view of a half-finished lead-acid battery to be processed by the positioning and clamping apparatus;

FIG. 8 is a side elevation schematically showing the lead-acid battery being processed by the lowering hoisting unit of the positioning and clamping apparatus;

FIG. 9 is a top plan view schematically showing a forward movement of the transporting plate of the positioning and clamping apparatus;

FIG. 10 is a sectional view taken along line 10-10 of FIG. 9;

FIG. 11 is a side elevation of the left portion of FIG. 9;

FIG. 12 is a top plan view schematically showing the limiting plate of the positioning and clamping apparatus clamping the transporting plate;

FIG. 13 is a sectional view taken along line 13-13 of FIG. 12;

FIG. 14 is a side elevation of the left portion of FIG. 12; and

FIG. 15 is a perspective view of a finished lead-acid battery showing each lead bridge and the corresponding lead head being joined and fastened at the end of soldering.

### DETAILED DESCRIPTION OF THE INVENTION

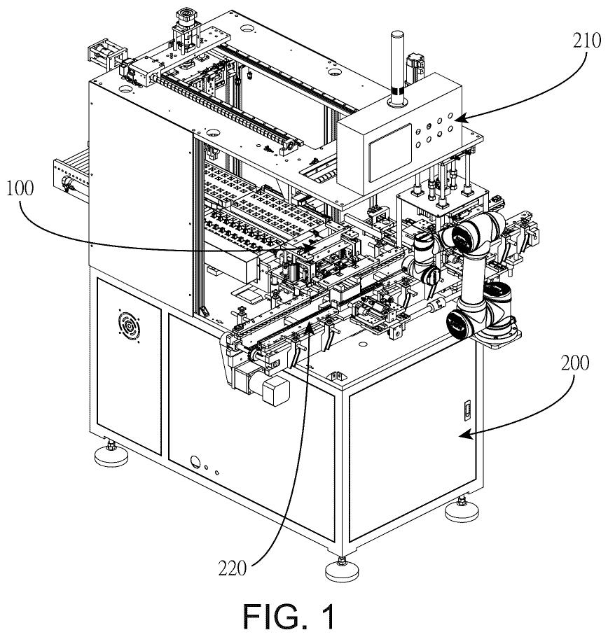

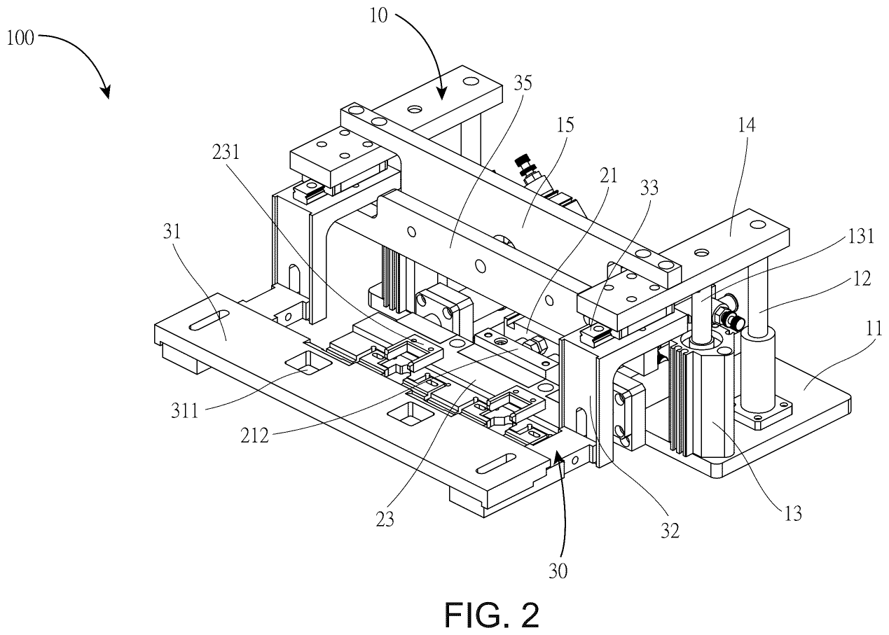

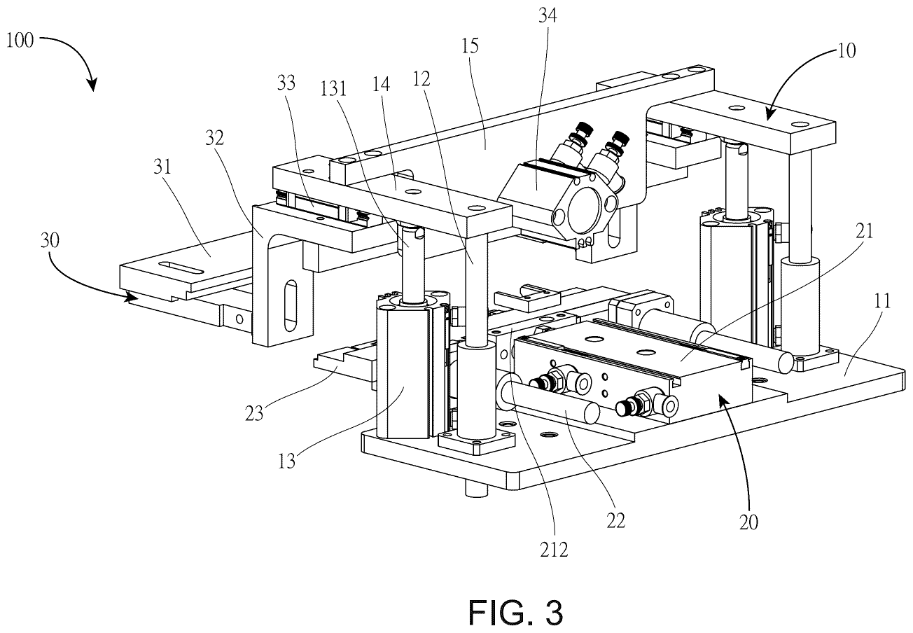

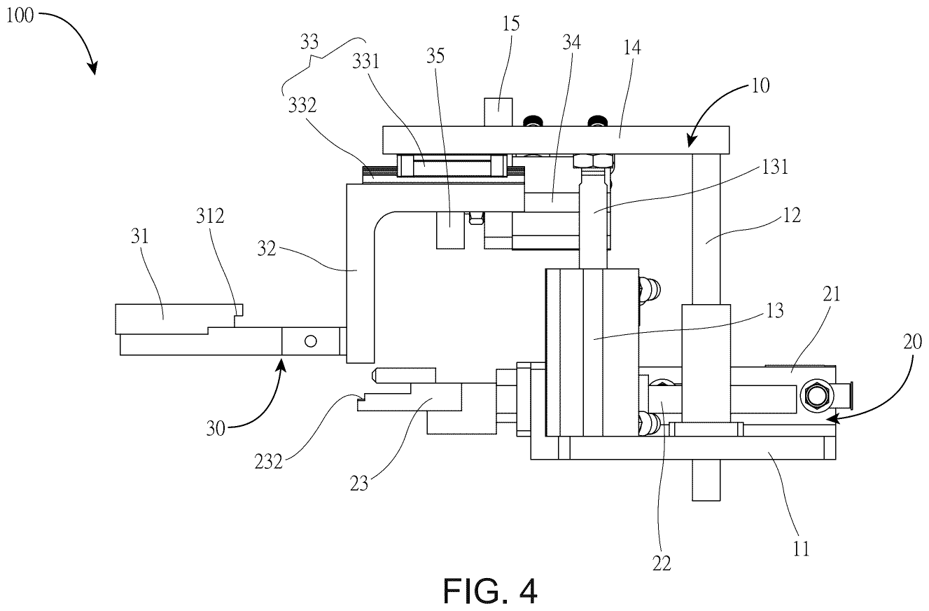

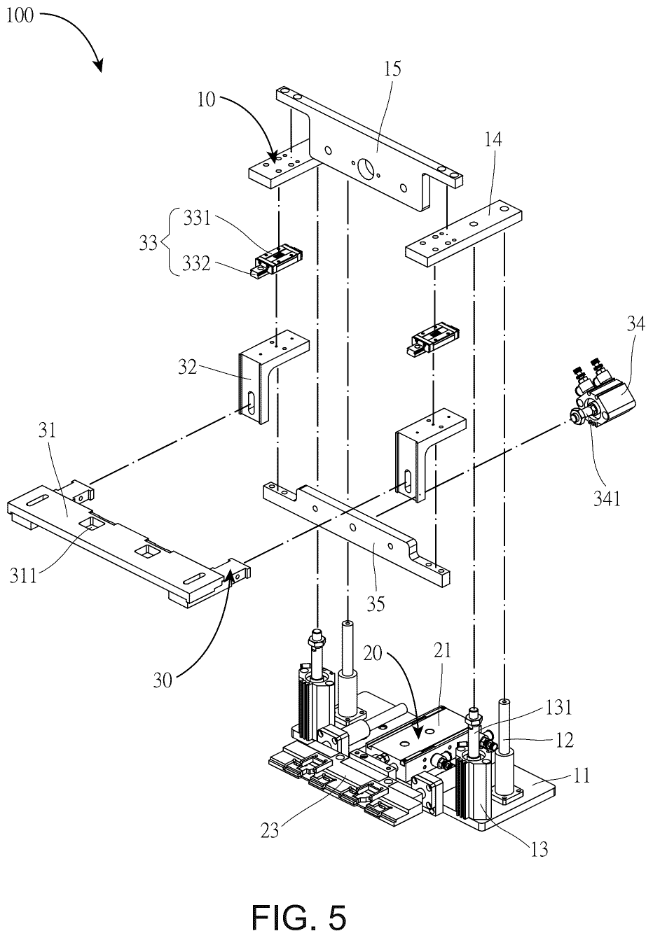

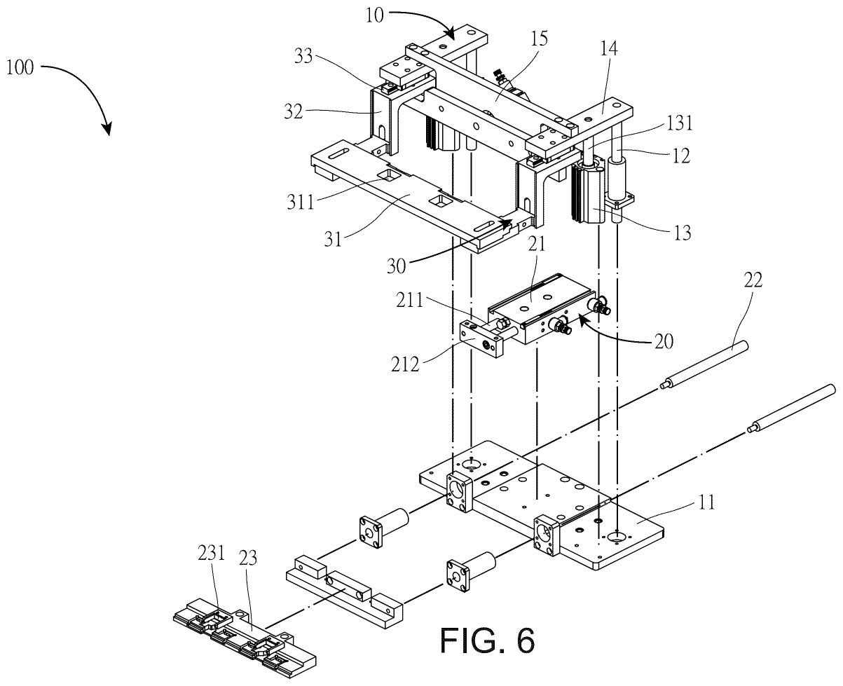

Referring to FIGS. 1 to 6, a positioning and clamping apparatus 100 according to a preferred embodiment of the invention is provided on a bed 200. A controlling unit 210 is provided on the positioning and clamping apparatus 100 above the bed 200 and a movement unit 220 is provided on the bed 200 respectively. The positioning and clamping apparatus 100 is electrically connected to the controlling unit 210 and comprises the following components as discussed in detail below.

A hoisting unit 10 is provided at one side of the movement unit 220 and comprises a support plate 11, two piston members 12, two first actuators 13, two hoisting plates 14, and an interconnection plate 15. The piston members 12 are provided on two sides of the support plate 11 respectively and the first actuators 13 are also provided on two sides of the support plate 11 respectively. The piston member 12 is adjacent to the first actuator 13 of the same side. The hoisting plate 14 is provided on tops of both the piston member 12 and the first actuator 13 of the same side. The first actuator 13 includes a first piston 131 threadedly secured to the hoisting plate 14. The interconnection plate 15 is provided across the hoisting plates 14. The first pistons 131 may threadedly raise or lower the hoisting plates 14 which in turn raise or lower the interconnection plate 15.

A transporting unit 20 comprises a second actuator 21, two movement rods 22, and a transporting plate 23. The second actuator 21 and the movement rods 22 are provided on the support plate 11. The second actuator 21 includes two parallel second pistons 211 and an idler plate 212 provided at open ends of the second pistons 211. The idler plate 212 is secured to the transporting plate 23. The movement rods 22 are disposed at two sides of the second actuator 21 respectively. One ends of the movement rods 22 are secured to the transporting plate 23. The transporting plate 23 is disposed at one end of the support plate 11. Thus, the second pistons 211 may move the idler plate 212 forward or rearward and in turn the idler plate 212 moves the movement rods 22 and the transporting plate 23 forward or rearward. The transporting plate 23 includes two spaced transporting seats 231 and a first shoulder 232 at an end.

A micro adjustment positioning unit 30 comprises a limiting plate 31, two follower plates 32, two sliding members 33, a third actuator 34, and a positioning plate 35. The limiting plate 31 is provided on one end of the transporting plate 23 opposing the support plate 11. The limiting plate 31 includes two limiting holes 311 aligned with the transporting seats 231 of the transporting plate 23 respectively, and a second shoulder 312 at an end. The follower plate 32 is shaped as an inverted L, under the hoisting plates 14, and secured to the limiting plate 31. The sliding member 33 is disposed between the hoisting plate 14 and the follower plate 32 of the same side. The sliding member 33 includes a sliding block 331 secured to the hoisting plate 14, and a rail 332 provided on the follower plate 32. The sliding block 331 may slide on the rail 332. The third actuator 34 is secured to the interconnection plate 15 and includes a third piston 341 passing through the interconnection plate 15 and threadedly secured to the positioning plate 35. The positioning plate 35 is secured to the follower plate 32. Thus, the third piston 341 may move the positioning plate 35 forward or rearward and in turn the positioning plate 35 moves the follower rods 32 and the limiting plate 31 forward or rearward.

The first actuators 13, the second actuator 21, and the third actuator 34 are pneumatic or hydraulic cylinders.

As stated above, the sliding member 33 is secured to both the hoisting plate 14 and the follower plate 32 of the same side and the follower plates 32 are secured to the limiting plate 31. When the first actuators 13 actuate the first pistons 131 to move, the first pistons 131 may raise or lower the hoisting plates 14. And in turn, the interconnection plate 15, the positioning plate 35, the follower plates 32, and the limiting plate 31 may raise or lower.

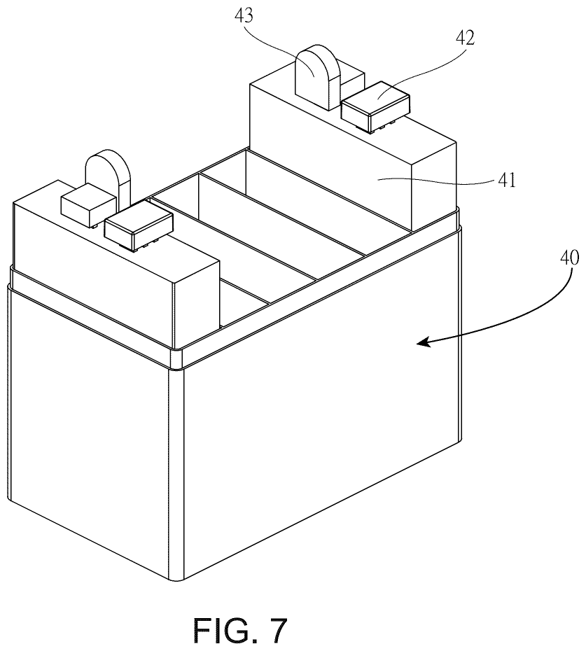

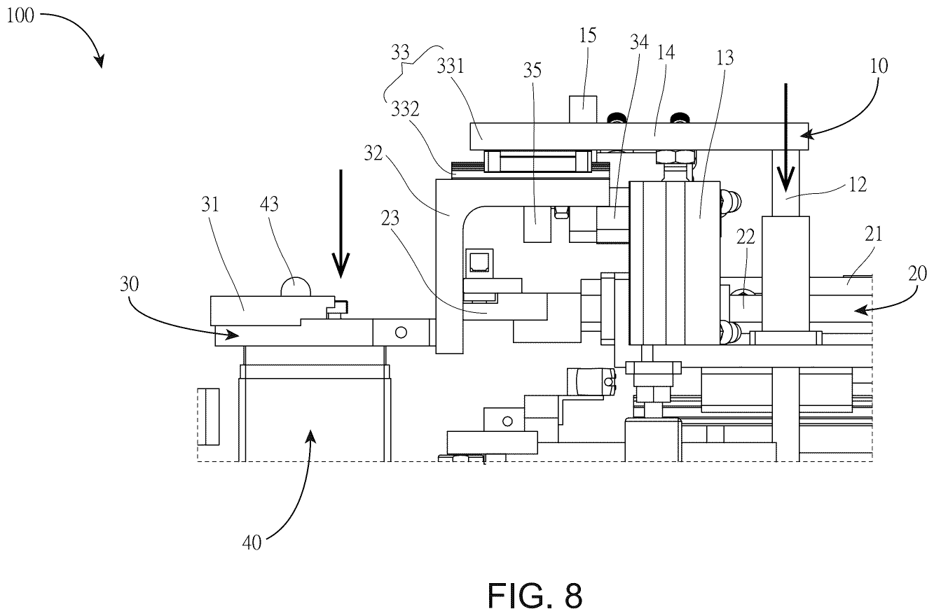

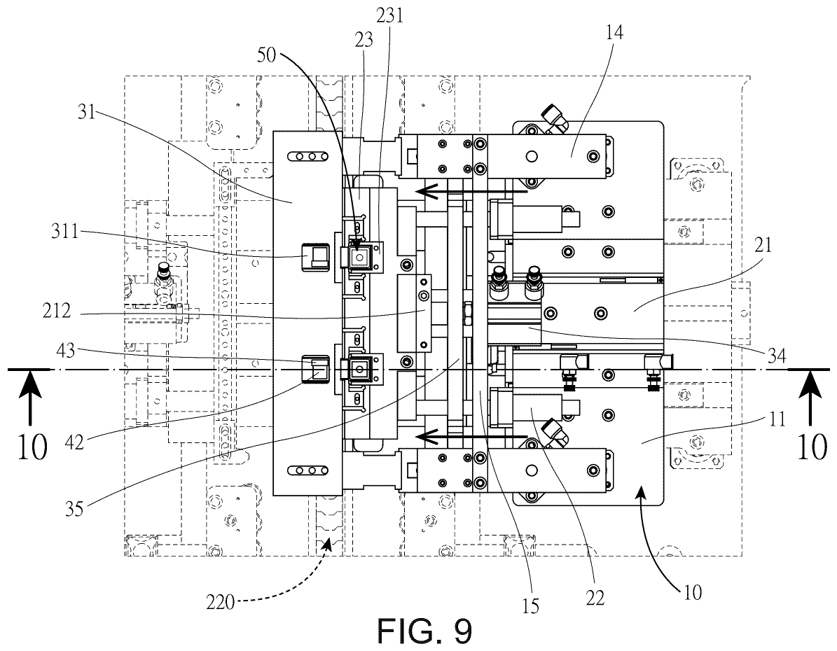

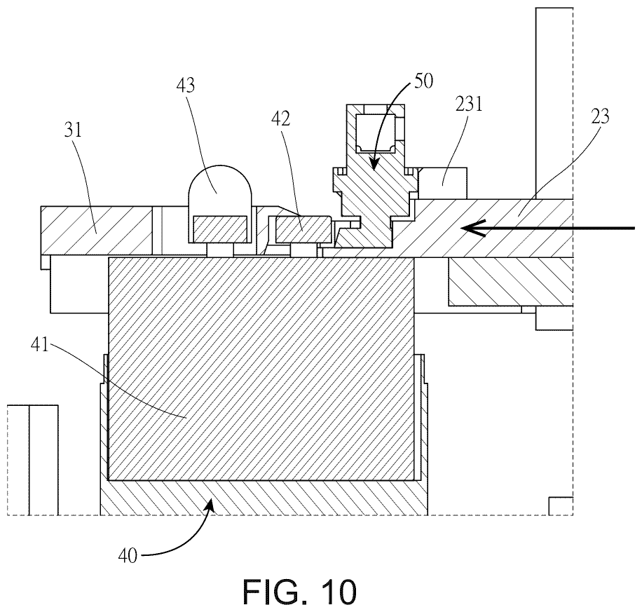

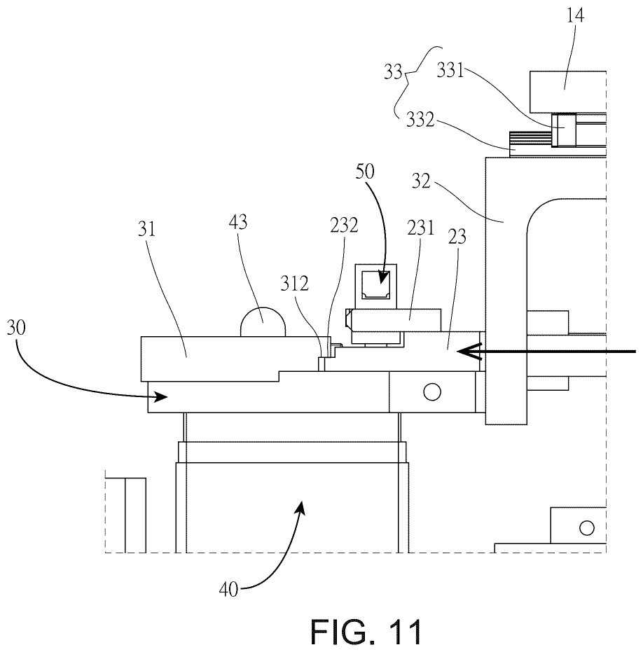

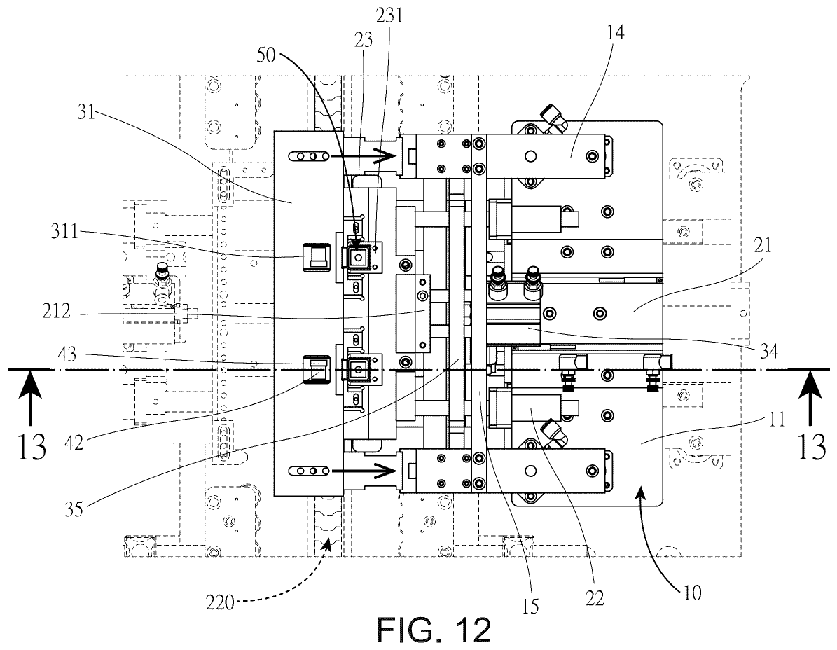

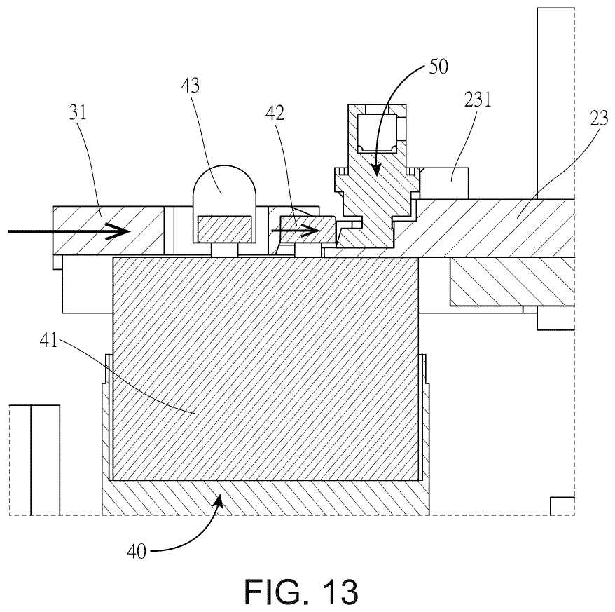

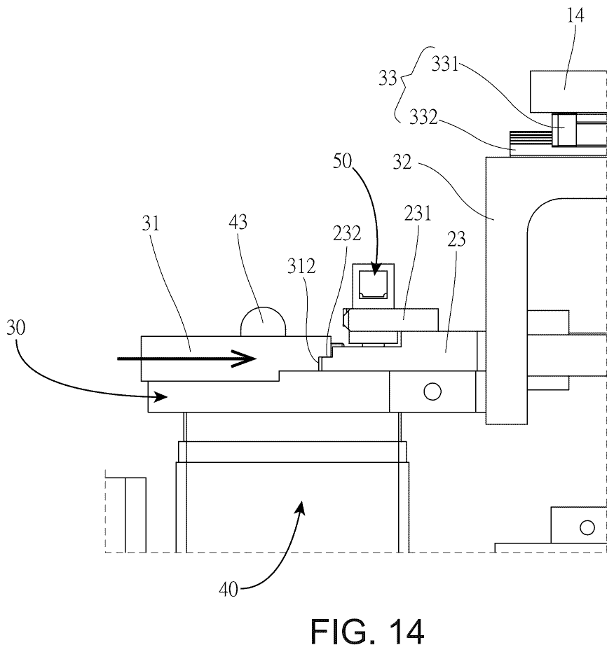

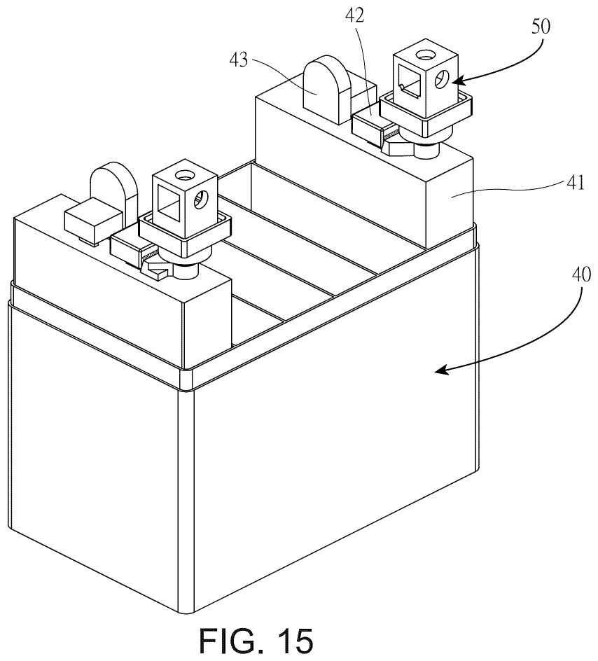

Referring to FIGS. 7 to 15 in conjunction with FIG. 1, an operation of the invention is discussed in detail below. The movement unit 220 moves a half-finished lead-acid battery 40 forward. The lead-acid battery 40 includes a plurality of (e.g., two) cell electrode plate groups 41 including a lead bridge 42 on top, and a connection member 43 besides the lead bridge 42 (as shown in FIG. 7). When the lead-acid battery 40 is transported to one side of the hoisting unit 10 and directly under the limiting plate 31, the controlling unit 210 instructs the first actuators 13 to actuate. And in turn, the first pistons 131 retract to lower the hoisting plates 14. And further in turn, the interconnection plate 15, the positioning plate 35, the follower plates 32, and the limiting plate 31 may lower until the limiting plate 31 presses the cell electrode plate groups 41 of the lead-acid battery 40 and the connection members 43 pass through the limiting holes 311 respectively (as shown in FIG. 8). The controlling unit 210 instructs the second actuator 21 to actuate. And in turn, the second pistons 211 extend to push the idler plate 212. And further in turn, the movement rods 22 and the transporting plate 23 move toward the limiting plate 31. A lead head 50 is clamped by each transporting seat 231 (as shown in FIGS. 9 to 11). Next, the controlling unit 210 instructs the third actuator 34 to actuate. And in turn, the third piston 341 retracts. And further in turn, the positioning plate 35, the follower plates 32, and the limiting plate 31 move toward the transporting plate 23. The second shoulder 312 of the limiting plate 31 moves to a position proximate the complementary first shoulder 232 of the transporting plate 23. Thus, the lead bridge 42 and the lead head 50 are joined (as shown in FIGS. 12 to 14). As such, a positioning and clamping process of the lead bridge 42 and the lead heads 50 is finished and a subsequent soldering of the same is facilitated. Finally, a lead-acid battery 40 is finished (as shown in FIG. 15).

The invention has the following advantages and benefits in comparison with the conventional art: the transporting unit 20 and the micro adjustment positioning unit 30 may be activated to cause the limiting plate 31 to contact the transporting plate 23. Thus, the lead bridge 42 and the lead head 50 at the same side of the lead-acid battery 40 are joined. This finishes the positioning and clamping process of the lead bridge 42 and the lead head 50. The drawbacks of the conventional assembling process of the lead-acid battery are eliminated. Moreover, both labor and time are saved, and efficiency is increased.

While the invention has been described in terms of preferred embodiments, those skilled in the art will recognize that the invention can be practiced with modifications within the spirit and scope of the appended claims.

What is claimed is:

1. A positioning and clamping apparatus for cell electrode plate groups, lead bridges, and lead heads of a lead-acid battery, comprising:
a hoisting unit comprising a support plate, two piston members, two first actuators, two hoisting plates, and an interconnection plate wherein the piston members are disposed on two sides of the support plate respectively, the first actuators are disposed on the sides of the support plate respectively, the piston member is adjacent to the first actuator of the same side, the hoisting plate is disposed on tops of both the piston member and the first actuator of the same side, each of the first actuators include a first piston threadedly secured to the hoisting plate, the interconnection plate is disposed across the hoisting plates, and the first pistons are configured to threadedly raise or lower the hoisting plates which in turn raise or lower the interconnection plate;
a transporting unit comprising a second actuator, two movement rods, and a transporting plate wherein the second actuator and the movement rods are disposed on the support plate, the second actuator includes two parallel second pistons secured to the transporting plate, the movement rods are disposed at two sides of the second actuator respectively, first ends of the movement rods are secured to the transporting plate, and the transporting plate is disposed at a first end of the support plate so that the second pistons are configured to move the movement rods and the transporting plate forward or rearward; and
a micro adjustment positioning unit comprising a limiting plate, two follower plates, two sliding members, a third actuator, and a positioning plate wherein the limiting plate is disposed on a first end of the transporting plate opposing the support plate, the follower plate is disposed under the hoisting plates and secured to the limiting plate, each of the sliding members are disposed between the hoisting plate and the follower plate of the same side, the third actuator is secured to the interconnection plate and includes a third piston passing through the interconnection plate and threadedly secured to the positioning plate, and the positioning plate is secured to the follower plate so that the third piston is configured to move the positioning plate forward or rearward and in turn the positioning plate is configured to move the follower rods and the limiting plate forward or rearward.

2. The positioning and clamping apparatus of claim 1, wherein the transporting plate includes two spaced transporting seats and the limiting plate includes two limiting holes aligned with the transporting seats of the transporting plate respectively.

3. The positioning and clamping apparatus of claim 1, wherein the second actuator further comprises an idler plate disposed at first ends of the second pistons, the idler plate being secured to the transporting plate so that the second pistons are connected to the transporting plate indirectly.

4. The positioning and clamping apparatus of claim 1, wherein the transporting plate includes a first shoulder at an end, and the limiting plate includes a second shoulder at an end.

5. The positioning and clamping apparatus of claim 1, wherein each of the sliding members include a sliding block secured to the hoisting plate, and a rail disposed on the follower plate; and wherein the sliding block is configured to slide on the rail.

6. The positioning and clamping apparatus of claim 1, wherein the first actuators, the second actuator, and the third actuator are pneumatic or hydraulic cylinders.
